(19) United States
(12) Patent Application Publication
(10) Pub. No.: US 2013/0130563 A1
(43) Pub. Date: May 23, 2013

(54) Electrically Conducting Screw Connection And Special Screw For Such A Screw Connection

(71) Applicants: Wolfgang Giraud, Nurnberg (DE); Thorsten Schraer, Gerolsbach (DE)

(72) Inventors: Wolfgang Giraud, Nurnberg (DE); Thorsten Schraer, Gerolsbach (DE)

(73) Assignee: RUIA GLOBAL FASTENERS AG, Neuss (DE)

(21) Appl. No.: 13/702,354

(22) PCT Filed: Jun. 7, 2011
(86) PCT No.: PCT/DE2011/050018

§ 371 Date: Jan. 31, 2013

(30) Foreign Application Priority Data
Jun. 9, 2010 (DE) DE202010007769

(51) Int. Cl. H01R 4/30

(52) U.S. Cl. CPC H01R 4/307
USPC 439/784

(57) ABSTRACT

The invention relates to an electrically conducting screw connection between two parts (10, 12) which are fastened to each other by a screw (16) having a screw head (18) and a shaft (22) and by a nut (28), wherein the screw (16) extends through a hole (14) in one of the parts (10), wherein the electrical contact between the other part (12) and the screw (16) is established by teeth (27) on the workpiece-side surface of the screw head (18) and/or of the nut (28) or of a washer (30) arranged between the nut (28) and the outer part (12), while the contact between the screw (16) and the one part (10) is established by elevations (26) on the shaft (22) of the screw (16), the outer diameter of the elevations being slightly greater than the inner diameter of the hole (14) and the elevations being arranged between the external thread (24) and the screw head (18), wherein the elevations (26) have flanks (42, 44) that extend at an angle and that meet each other at an angle of approximately 60° and that are connected to each other by circular arc sections (46, 48).

### TECHNICAL FIELD

The invention relates to an electrically conducting screw connection between two parts screwed together by a screw having a screw head and a shaft, and by a nut, the screw running through a bore in one part. The present invention also relates to a special screw for such screw connections having a head and a shaft with an external thread.

Since modern motor vehicles are increasingly equipped with highly sensitive electronics, it is necessary for all the electrically conducting parts, in other words substantially all the metal parts of a motor vehicle, to have a low-resistance electrically conductive connection to earth.

### PRIOR ART

For this purpose, additional, large earth cables or other devices were hitherto used. This constantly led to additional parts having to be installed, which meant additional costs and additional weight, with these parts additionally often not satisfactorily fulfilling their function, as the contact was frequently too poor, or was reduced over time by corrosion and electrochemical effects. For example, the automotive industry nowadays demands an earth contact with two cables, each ten millimetres in diameter, for a steering box made of aluminium.

Direct contact between the individual components of a vehicle is, in particular, no longer automatically provided nowadays, as the parts are generally already coated and/or painted before final assembly for anti-corrosion reasons, and because aluminium parts form an insulating passivation layer of aluminium oxide by themselves.

To achieve a completely different type of object, namely the connection of two components by means of a screw connection, which, however, has the mechanical qualities of a riveting connection, a screw connection between two parts screwed together by a screw having a screw head and a shaft with an external thread, and by a nut, is already known from U.S. Pat. No. 2,019,049 A, in which elevations are provided on the shaft of the screw, the external diameter of which elevations is slightly larger than the internal diameter of the bore and which elevations are arranged between the external thread and the screw head. Likewise, a special screw is known from this prior art, having a head and a shaft with an external thread, in which elevations are arranged on the shaft between the screw head and the external thread, which project beyond the external diameter of the external thread on the shaft of the special screw.

According to this citation, the elevations on the shaft of the screw are, however, configured as sharp-edged saw teeth. This mode of configuration is well suited to the rivet-type connection, for which the screw according to the citation is provided, but does not lead to an adequate extent to the desired improvement in the electrical contact between the components, as the elevations in the screw projecting in a saw tooth-like and sharp-edged manner, according to the citation, lead to abrasion of material in the components to be connected during screwing, such that the electrical contact is not in any way improved, but, rather, worsened.

### PRESENTATION OF THE INVENTION

According to the invention, a low-resistance electrical connection is thus to be produced between two components. This object is achieved by an electrically conducting screw connection according to claim 1 or by a special screw for electrically conducting screw connections according to claim 7.

It is particularly preferred in this case if the elevations are configured as spiral-shaped circumferential bulges on the surface of the shaft, as the bulges can then easily be produced simultaneously with the rolling of the external screw thread. It is particularly preferred in this case if the bulges have a different pitch to the external thread. This leads, during screwing, to a relative movement between the screw and the inner workpiece, whereby paint layers, coatings or passivation layers (oxide layers) are scraped off or broken through by the relative movement of the bulges during screwing. As a result, the electrical resistance of the connection is significantly reduced.

It is particularly preferred in this case if the pitch of the bulges is greater than the pitch of the external thread.

In order to avoid later symptoms of corrosion, the elevations may be provided with grease or wax.

In order to prevent the penetration of corrosive substances, a ring can be arranged running round the outside of the teeth on the workpiece-side surface of the screw head.

### BRIEF DESCRIPTION OF THE DRAWINGS

The present invention will be described in more detail below by reference to the embodiment shown in the accompanying drawings.

FIG. 1 shows a screw connection according to the invention having a special screw according to the invention, in a sectional view along the rotational axis of the screw;

FIG. 2 shows a special screw according to the invention from the side;

FIG. 3 shows the plan view of the workpiece-side surface of the screw head of the screw of FIG. 2;

FIG. 4 shows a detailed enlargement of the teeth of the screw head of FIG. 2; and

FIG. 5 shows the detail X of FIG. 2.

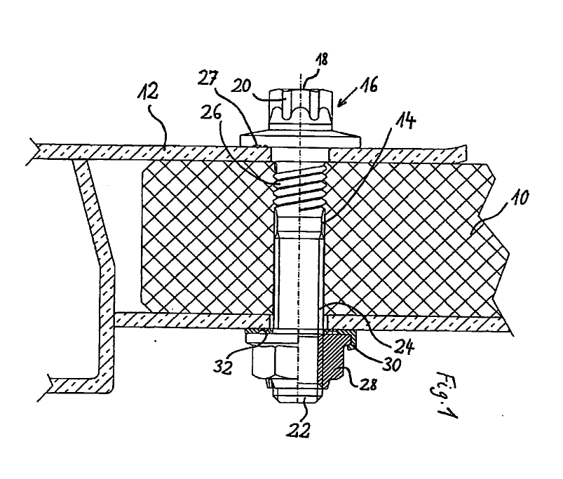

FIG. 1 shows a screw connection according to the invention, partly cut along the rotational axis of the screw.

### BEST METHOD FOR IMPLEMENTING THE INVENTION

In the embodiment shown here, a part of a steering box housing made of aluminium is enclosed, as the inner part 10, by a crossmember made of steel, as the outer part 12, and both parts are connected by screwing by means of a screw 16 running through a bore in the inner part 10 and two holes in the outer part 12, and by means of a nut 28 with a washer 30.

In the present case, the screw connection is, however, implemented according to the invention in such a way that it simultaneously produces a low-resistance electrical contact between the components 10 and 12, even if these are painted, coated or covered with a passivation layer of aluminium oxide.

The screw 16, as is conventional, has a screw head 18 in this case with a hexalobular external force application device 20 and a shaft 22. As is conventional, the shaft 22 of the screw 16 is provided with an external thread 24. According to the invention, this external thread 24 does not, however, extend to the screw head 18. Rather, a spiral-shaped circumferential elevation 26 is provided below the screw head 18, the pitch of which elevation is greater than the thread pitch of the external thread 24. Furthermore, the elevation 26 has a rounded cross-section, which extends beyond the external diameter of the external thread 24, and is dimensioned such that it is slightly larger than the internal diameter of the bore 14. This configuration of the elevations 26 means that, when the screw 16 is tightened, these elevations dig into the internal wall of the bore 14 slightly, or scrape off and/or pierce a passivation layer, which could have formed on the internal wall of the bore 14, as the housing part 10 consists of aluminium. The elevations 26 thus produce a low-resistance electrical contact between the housing part 10 and the screw 16.

When the outer part 12 is provided with a painting or coating, for example with a cataphoretic painting (cataphoretic dip painting—CDP), a low-resistance contact now also has to be produced according to the invention between this outer part 12 and the screw 18. According to the invention, this may take place by teeth 27, which are attached to the workpiece-side surface of the screw head 18 and are described in more detail in FIGS. 3 and 4.

In the present case, the screw is screwed by means of a counter-nut 28 and a washer 30. In the embodiment shown here, the washer 30 is also provided with punchings 32, which have an edge produced by the punching process and projecting in the direction of the workpiece 12, and thereby also produce, on this side, a good, low-resistance contact between the washer and the outer part 12.

Alternatively, the washer 30 could have been dispensed with and the nut 28 also provided with corresponding teeth, it thus being possible to produce an electric contact between the nut 28 and the outer part 12 despite a painting or coating of this part 12.

According to the invention, there is therefore the possibility both of using the teeth 27 under the screw head 18 for the electrical connection between the screw 16 and the outer part 12 and, alternatively or additionally to this, a washer 30 provided with corresponding teeth or elevations may be provided, or this washer may be omitted and the nut 28 can be provided with corresponding teeth and screwed directly on the outer part 12.

In most cases, it is sufficient according to the invention, however, to produce the electrical connection between the screw and outer part 12 by means of the teeth 27 on the lower side of the screw head 18.

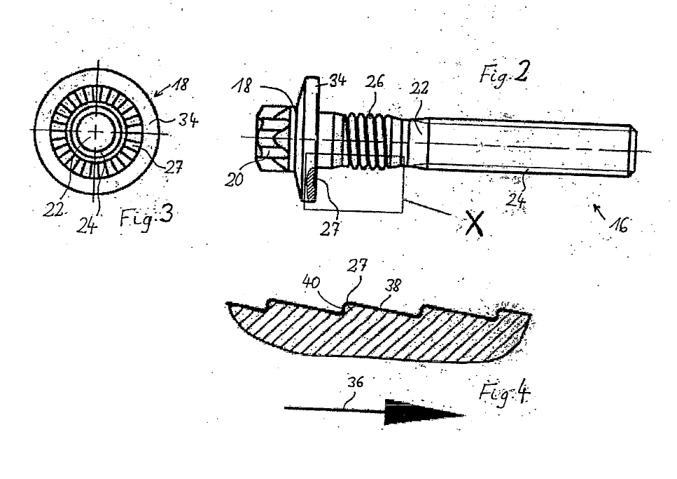

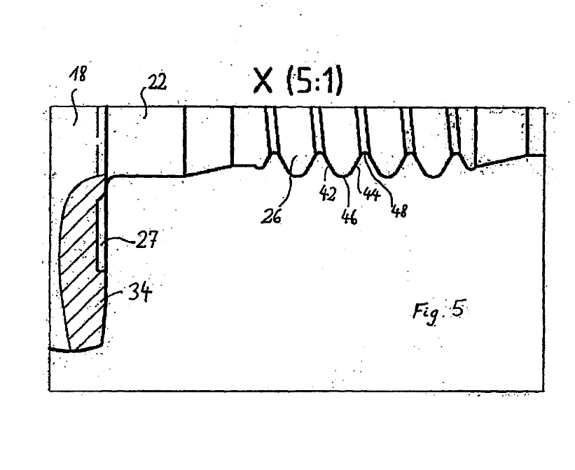

FIG. 2 shows a special screw according to the invention, as has been used in the screw connection according to FIG. 1, from the side. The arrangement of the external thread 24, the spiral-shaped circumferential bulges 26 and the screw head 18 is illustrated again here. The bulges 26 and the teeth 27 are shown more closely the detail X (shown in FIG. 5) and in FIG. 4.

FIG. 3 shows a plan view of the workpiece-side surface, in other words, the shaft-side surface of the screw head 18 of the screw 16 according to the invention. The shaft 22 with the external thread 24 can be seen in the centre. The radially circumferential teeth 27 configured in a sawtooth shape adjoin said external thread toward the outside. The teeth 27 are shown in more detail in FIG. 4.

A ring 34 protruding toward the workpiece and forming a seal for the screw connection to the outside, and therefore also a corrosion protection for the workpiece surface of the outer part 12 torn open by the teeth 27, is located outside the teeth 27.

FIG. 4 shows a detailed sectional view of the teeth 27. It can clearly be seen that the teeth 27, in the tightening direction, which is shown by the arrow 36, have flanks 38 running in an extraordinarily flat manner, while, in the opposite direction, they have very short, very steep flanks 40 running virtually perpendicular to the workpiece surface.

FIG. 5 shows the detail X of FIG. 2. A part of the screw head 18, in particular the corresponding workpiece-side surface with the outer circumferential ring 34 and the teeth 27, is again shown here on the left of the picture.

The shape of the spiral-shaped circumferential bulges 26 can be seen particularly clearly in FIG. 5.

These have obliquely running flanks 42, 44, which, in each case, impinge on one another at an angle of about 60° and are interconnected by circular arc portions 46, 48. In this case, the outer circular arc 46 has a larger radius than the inner circular arc 48.

According to the invention, the region of the bulges 26 of the special screw 16 may be provided with a sealant or lubricant, for example grease or wax, before the screwing connection according to the invention. This sealant or lubricant may optionally also have already been applied to the screw during production, before the screwing of the screw 16, and in the meantime be touch-dry. As a result, on the one hand, the force required for screwing is reduced, as the friction between the bulges 26 and the internal wall of the bore 14 is reduced and, on the other hand, the penetration of water into this region of the screw connection, and therefore corrosion effects, are thus avoided.

The advantage of the present invention is that the earth connection between various motor vehicle parts can be ensured without additional earth cables, even when the corresponding parts are already covered with a painting, a coating or a passivation layer before the screw connection. In addition, the present invention has the advantage compared with the previously conventional earth cable that high-frequency interferences are also conducted away very well. This is not necessarily the case with earth cables, owing to their inevitable inductance thereof.

In contrast to this, a corresponding contact is produced according to the invention between the screw 16 and the outer part 12 by the teeth 27 under the screw head 18, which cut through the paint layer on the outer part 12. Alternatively or additionally, this may take place by means of corresponding teeth or other projecting burrs on a washer, the washer being able to be arranged both under the screw head and under a nut. Moreover, the nut may also be provided with corresponding teeth if no washers are used.

The screw head, the washer or the nut may also be provided with an outer circumferential ring, in order to preserve the screw connection, but in particular the contact points with the destroyed paint on the outer part 12, from the penetration of water and therefore from corrosion.

The further electrical connection between the screw 16 and the inner part 10 is produced by the bulges 26. These have a slightly larger diameter than the bore 14. As a result, they break through the passivation layer on the internal wall of the bore 14 and thus produce a low-resistance electrical contact between the screw 16 and the inner part 10. The required screwing force can be reduced by coating the bulges 26 with a grease or wax (this screwing force is increased as the bulges have to press into the internal wall of the bore 14) and the formation of a new passivation layer and/or symptoms of corrosion, in particular electrochemical corrosion, is simultaneously prevented by a grease or wax layer of this type. The bulges, in this case, preferably have a pitch which is slightly greater than the pitch of the external thread 24, such that the spiral-shaped bulge continuously displaces relative to the internal wall of the bore 14 during the screwing of the screw 18 and therefore additionally removes the passivation layer on the internal wall of the bore 14. This applies, in particular, to cases in which the screw is to be inserted into an internal thread bore of another workpiece.

In addition, in a connection with the screw and nut on the workpiece-side surface of the nut, a toothed system or other projections may also be provided. When using a connection with a nut and washer, the washer can accordingly be provided with teeth or other projecting elements in order to also produce a good contact between the screw and the outer part 12 at the other end of the screw.

1. Electrically conducting screw connection between two parts (10, 12) screwed together by a screw (16) having a screw head (18) and a shaft (22), and by a nut (28), said screw connection comprising:
the screw (16) running through a bore (14) in one of the two parts (10);
electrical contact between an outer part (12) and the screw (16) being produced by teeth (27) on a workpiece-side surface of the screw head (18) or the nut (28) or a washer (30) arranged between the nut (28) and the outer part (12); and
electrical contact between the screw (16) and the one part (10) being produced by elevations (26) on the shaft (22) of the screw (16),
wherein an external diameter of the elevations is slightly larger than an internal diameter of the bore (14) and which elevations are arranged between an external thread (24) and the screw head (18), the elevations (26) having obliquely running flanks (42, 44) which impinge on one another at an angle of about 60° and are interconnected by circular arc portions (46, 48).

2. The electrically conducting screw connection according to claim 1, wherein the elevations (26) are configured as spiral-shaped circumferential bulges on a surface of the shaft (22).

3. The electrically conducting screw connection according to claim 2, wherein the bulges (26) have a different pitch to the external thread (24).

4. The electrically conducting screw connection according to claim 2, wherein the pitch of the bulges (26) is greater than the pitch of the external thread (24).

5. The electrically conducting screw connection according to claim 1 wherein the elevations (26) are provided with a sealant or lubricant.

6. The electrically conducting screw connection according to claim 1 wherein the teeth (27) on the workpiece-side surface of the screw head (18) are surrounded by a ring (34).

7. A special screw (16) for electrically conducting screw connections having a screw head (18) and a shaft (22) with an external thread (24), said special screw comprising:
a workpiece-side surface of the screw head (18) being provided with teeth (27) and elevations (26) arranged on the shaft (22) between the screw head (18) and the external thread (24), which elevations project beyond an external diameter of the external thread (24) on the shaft (22) of the special screw (16), wherein the elevations (26) have obliquely running flanks (42, 44) which impinge on one another at an angle of about 60° and are interconnected by circular arc portions (46, 48).

8. The special screw (16) according to claim 7, wherein the elevations (26) are configured as spiral-shaped circumferential bulges on a surface of the shaft (22).

9. The special screw (16) according to claim 8, wherein the bulges (26) have a different pitch to the external thread (24).

10. The special screw (16) according to claim 8, wherein the pitch of the bulges (26) is greater than the pitch of the external thread (24).

11. The special screw (16) according to claim 7, wherein the elevations (26) are provided with a sealant or lubricant.

12. The special screw (16) according to claim 7, wherein the teeth (27) on the workpiece-side surface of the screw head (18) are surrounded by a ring (34).

13. The electrically conducting screw connection according to claim 1, wherein outer circular arc portion (46) has a larger radius than inner circular arc portion (48).

14. The special screw (16) according to claim 7, wherein outer circular arc portion (46) has a larger radius than inner circular arc portion (48).

15. An electrically conducting screw connection between an inner part (10) and an outer part (12) screwed together by a screw (16) having a screw head (18) and a shaft (22), and by a nut (28), said screw connection comprising:
the screw (16) running through a bore (14) in the inner part (10);
electrical contact between the outer part (12) and the screw (16) being produced by teeth (27) on a workpiece-side surface of the screw head (18) or on the nut (28) or on a washer (30) arranged between the nut (28) and the outer part (12); and
electrical contact between the screw (16) and the inner part (10) being produced by elevations (26) on the shaft (22) of the screw (16),
wherein the elevations are arranged between an external thread (24) and the screw head (18), have an external diameter that is slightly larger than an internal diameter of the bore (14), and have obliquely running flanks (42, 44) that impinge on one another at an angle of about 60° and are interconnected by circular arc portions (46, 48).
